(19) United States
(12) Patent Application Publication
(10) Pub. No.: US 2026/0011991 A1
(43) Pub. Date: Jan. 8, 2026

(54) CONNECTION BODY, EXPLOSION-PROOF LINE FEED-THROUGH AND/OR LINE ENTRY AS WELL AS METHOD FOR PRODUCING SAME

(71) Applicant: R. STAHL SCHALTGERÄTE GMBH, Waldenburg (DE)

(72) Inventors: Martina SANDOW, Öhringen (DE); Tim STECKLING, Pfedelbach (DE)

(21) Appl. No.: 18/992,758

(22) PCT Filed: Jul. 10, 2023
(86) PCT No.: PCT/EP2023/069043

§ 371 Date: Jan. 9, 2025

(30) Foreign Application Priority Data
Jul. 11, 2022 (DE) 10 2022 117 201.5

(51) Int. Cl. H02G 3/22

(52) U.S. Cl. CPC H02G 3/22

(57) ABSTRACT

The present disclosure relates to a connecting body for producing an explosion-proof cable entry gland and/or cable bushing. The connecting body has three sections arranged next to one another in a longitudinal direction, namely a deformation section, a transition section and a connecting section. The transition section preferably directly adjoins the deformation section and/or the connecting section. A line duct which extends in the longitudinal direction passes through the connecting body, wherein a line can be fed through the line duct in an initial state of the connecting body. The deformation section is provided and configured to be plastically deformed so that a flameproof and force-fitting connection is produced between the deformation section and the line which is fed through the line duct. The transition section decouples the deformation section from the connecting section and prevents the plastic deformation of the deformation section also leading to undesired deformation of the connecting section. The connecting section is provided and configured to produce a flameproof connection to a wall opening or a lead-through opening of an external part.

### CROSS REFERENCE TO RELATED APPLICATIONS

This application is a National Stage of PCT Application No. PCT/EP2023/069043 filed on Jul. 10, 2023, which claims priority to German Patent Application No. DE 10 2022 117 201.5 filed on Jul. 11, 2022, the contents each of which are incorporated herein by reference thereto.

### TECHNICAL FIELD

The present disclosure refers to a connection body for an explosion-proof line feed-through, an explosion-proof line feed-through and/or line entry comprising a connection body as well as a method for producing an explosion-proof line feed-through.

### BACKGROUND

The explosion-proof line entry or line feed-through serves to guide a line, which can, for example, comprise at least one electrical conductor and/or at least one optical conductor, in an explosion-proof manner through a wall opening. For example, the wall opening can be present in a wall of an explosion-proof housing. The line feed-through thereby avoids that an ignition medium, for example hot gases, sparks, flames or the like, can pass through the wall opening into an area where an explosive atmosphere is present.

DE 10 2012 111 270 A1 describes an explosion-proof line feed-through for multi-core cables. The line feed-through comprises a connection body having a deformation section and a connection section. The connection section can be arranged in a wall opening of a housing wall. In the area of the deformation section, an inner sleeve consisting of elastomeric material is arranged between the line and the outer sleeve. The deformation section can be deformed radially inwardly in order to create a force-fit and flame-proof connection between the outer sleeve, the inner sleeve and the line.

The elastomeric inner sleeve provides the ability of guiding lines having different diameters through the outer sleeve in explosion-proof manner. The required degree of deformation of the deformation section can be limited by means of a suitable selection of the thickness of the inner sleeve. However, for feed-through of thin lines, the diameter of which is remarkably smaller than the maximum possible line diameter, a relatively high amount of elastomeric material is required. The thicker the inner sleeve, the lower the pressing force between the inner sleeve and the line, if the diameter change of the deformation section remains constant. This can potentially have disadvantageous effects on the connection between the inner sleeve and the line.

Another line feed-through is described in DE 10 2015 112 285 A1. There, a connection body is used, which can be deformed for connection with the line, wherein the deformed outer surface is concurrently the surface, which is used for connection with the wall opening or a feed-through opening in order to create a flame-proof gap. In this embodiment of the line feed-through, the deformation has to comply with high quality requirements so that the deformed outer surface complies with the requirements to a surface limiting a flame-proof gap.

### BRIEF SUMMARY

Starting from the prior art, it can be considered as object of the present disclosure to provide a connection body for an explosion-proof line feed-through that guarantees a reliable flame-proof connection with a line on one hand and a feed-through opening of an outer part on the other hand and that is suitable for different line diameters.

This object is solved by means of a connection body for producing an explosion-proof line entry and/or line feed-through, comprising: a line channel extending in a longitudinal direction through the connection body, wherein in an initial condition of connection body the line channel is configured to insert and guide a line therethrough, a deformation section made of a plastically deformable material configured to be plastically deformed starting from the initial condition of connection body, so that connection body takes a use condition, wherein the deformation section comprises a hollow cylindrical first longitudinal part having a first wall thickness in the initial condition and wherein the deformation section is configured to abut against the line in the use condition and to establish a force-fit and flame-proof connection with the line, a connection section that is configured to be connected with a feed-through opening of an outer part or with a wall opening in a flame-proof manner, and a transition section made of a plastically deformable material that connects the connection section with the deformation section, wherein the transition section comprises a second wall thickness that is smaller than the first wall thickness and smaller than a third wall thickness in the connection section in the initial condition of the connection body. The connection body can be part of an explosion-proof line feed-through and can be used for creating an explosion-proof line feed-through.

The connection body according to the present disclosure has a line channel that extends completely through the connection body in a longitudinal direction. In an initial condition of the connection body prior to a plastic deformation the line channel is substantially cylindrical. Particularly, it can deviate from the cylindrical shape at its two ends arranged opposite to one another in longitudinal direction and may expand outwardly. With view in longitudinal section, this diameter expansion can be realized, for example, by means of a radius and/or chamfer at the channel ends.

The line channel is configured to insert and pass a line through the connection body in the initial condition of the connection body, so that the line completely extends through the line channel. The line can comprise at least one electrical conductor and/or at least one optical conductor. The line can optionally comprise a sheath made of plastic, for example to protect the at least one conductor and/or for the purpose of electrical insulation.

The connection body has a deformation section, a connection section and a transition section. The deformation section and the connection section are connected with one another via the transition section. Preferably the deformation section is an axial end section of the connection body. The transition section adjoins the deformation section particularly directly. It can also directly adjoin the connection section.

The deformation section is configured to be plastically deformed and consists of a plastically deformable material for this purpose. The transition section also consists of a plastically deformable material. In an embodiment the entire connection body can be configured monolithically and thus consist of a uniform material. The plastically deformable material that is at least used for the deformation section and the transition section is preferably a metal or a metal alloy, particularly a steel alloy.

In the initial condition the deformation section has a hollow cylindrical first longitudinal part. For example, this first longitudinal part can adjoin one channel end, preferably directly. In a preferred embodiment in the initial condition the deformation section has a second longitudinal part that adjoins the first longitudinal part preferably directly. In the second longitudinal part the wall thickness of the deformation section may decrease toward the transition section. The second longitudinal part can directly adjoin the transition section.

Starting from the initial condition the deformation section can be plastically deformed so that it is in a use condition. Thereby the deformation is carried out so that the inner diameter at least of the first longitudinal part of the deformation section is reduced and that at least the first longitudinal part of the deformation section abuts or is pressed against the line present in the line channel and thereby a force-fit and flame-proof connection is established with the line. Due to this flame-proof connection concurrently a strain relief for the line can be achieved.

The connection section is configured to be arranged in a wall opening or in a feed-through opening of an outer part in flame-proof manner. The connection section has to be provided with a precise outer geometry for this purpose.

According to the present disclosure a transition section is provided between the deformation section and the connection section, wherein the transition section is plastically deformed at least partly as well when the deformation section is plastically deformed. The transition section avoids that the plastic deformation of the deformation section also influences the connection section. It serves for decoupling the deformation section from the connection section so-to-speak and thereby allows comparably high degrees of deformation for connection with lines having different diameters. The arrangement of additional elastomeric material or an inner sleeve between the line and the deformation section is not necessary, however possible as an option. The inner diameter change of the deformation section can vary in a large range and can be adapted to the line diameter in order to guarantee a sufficient pressing force between the deformation section and the line.

The transition section has a smaller wall thickness compared with the connection section and the first longitudinal part of the deformation section and thus the transition section can be deformed more easily than the other sections of the connection body. In doing so, it can be achieved that the material flow during deformation of the deformation section is limited to the deformation section itself and the adjacent transition section and that no deformation of the connection section occurs. Thereby the defined outer geometry of the connection section can be maintained. Therefore, the connection section has the same outer shape and optionally additionally also the same inner shape in the use condition as in the initial condition. Thereby it is achieved that the connection section can be connected with the outer part in a simple and flame-proof manner.

The wall thickness of the connection section may vary. The wall thickness of the connection section here refers to a minimum or constant wall thickness in an axial area of the connection section in which the connection section comprises a connection outer surface provided and configured for forming the flame-proof gap together with the feed-through opening or the wall opening.

It is advantageous if the line channel is hollow cylindric in an initial condition of the connection body along a central channel section. The central channel section has a constant diameter that particularly defines the inner diameter of the connection body in the initial condition and the maximum usable line diameter for the insertion and the feed-through of a line. The central channel section extends in longitudinal direction along the entire transition section and along the entire first longitudinal part of the deformation section. Preferably, the central channel section extends adjacent to the transition section also into the connection section. Preferably, the central channel section extends entirely along the connection body between two opposite channel ends with view in longitudinal direction. In the area of the channel ends, the diameter of the line channel may increase outwardly. The diameter increase can be realized by means of a radius on the channel wall limiting the line channel, wherein the radius can be minimum 1.4 mm, for example.

It is preferred if the wall thickness of the first longitudinal part of the deformation section is minimum 25% of the minimum diameter of the line channel, when the connection body is in the initial condition (plastically non-deformed). The minimum diameter of the line channel is particularly defined by the diameter of the central channel section in the initial condition.

The wall thickness of the first longitudinal part of the deformation section can be at least 1.35 mm. The wall thickness of the connection section is preferably larger than the wall thickness of the deformation section.

It is advantageous if the wall thickness of the transition section in the initial condition is smaller than 2.0 mm or smaller than 1.5 mm. In a preferred embodiment the wall thickness of the transition section can be 1.0 mm.

The wall thickness of the deformation section can be maximum 6.0 mm. The maximum wall thickness of the deformation section can be twice the minimum wall thickness of the deformation section.

The wall thickness is respectively measured orthogonal to a central axis extending in longitudinal direction through the connection body.

In longitudinal direction the transition section can have a length of minimum 2.5 mm or minimum 2.8 mm. Due to this configuration, the decoupling of the deformation section from the connection section is further improved.

The transition section can be limited by means of a ring surface toward the connection section, wherein the ring surface is orientated orthogonal to the longitudinal direction.

The length of the transition section can be minimum 10% to minimum 13% of the outer diameter of the deformation section in the initial condition of the connection body. This applies particularly if the outer diameter of the deformation section in the initial condition of the connection body is larger than 10 mm. If the outer diameter of the deformation section in the initial condition of the connection body is maximum 10 mm, a constant length of the transition section can be provided of minimum 2.4 mm length and in an embodiment of 2.8 mm length.

Using any embodiment of the connection body described above, an explosion-proof line feed-through can be built up. In use condition of the connection body a flame-proof connection between the connection body and the line in the area of the deformation section is achieved due to the plastic deformation of the deformation section. Between the connection section and the line and between the transition section and the line, an interstice can be present in use condition of the connection body. The connection section is not influenced by the plastic deformation due to the decoupling by means of the transition section, so that the outer diameter and/or the inner diameter of the connection section is equal in the initial condition and in the use condition.

Preferably, no intermediate layer is present between the deformation section and the line, particularly no intermediate layer made of elastomeric material. The deformation section directly contacts the line.

In the explosion-proof condition of the line feed-through, a flame-proof connection between the connection section and a wall opening or a feed-through opening of an outer part is established. For this purpose, a flame-proof cylinder gap or a flame-proof threaded gap can be formed. The connection section can either be plugged into the wall opening or feed-through opening or can be alternatively screwed therein. The flame-proof gap is limited on one side by a surface of the wall opening or feed-through opening and on the other side by a connection outer surface on the connection section.

In turn, the optional outer part can be arranged in the wall opening in flame-proof manner, for example in gas-tight manner, for example in a wall opening of an explosion-proof housing. Such housing can be realized in the explosion-protection type “flame-proof enclosure (Ex-d)”.

For creation of the explosion-proof line feed-through, it can be proceeded as follows:

A connection body according to any embodiment described above is provided in the initial condition. In addition, a line is provided. If necessary, optionally, an outer part having a feed-through opening can be provided. The connection body or the outer part is configured to be arranged in a wall opening in a flame-proof manner.

The connection body is connected with the line in a force-fit and flame-proof manner. For this purpose, the line is guided through the line channel as long as the connection body is in the initial condition. Subsequently, the deformation section is deformed inwardly toward the line using a suitable deformation tool so that the inner diameter of the deformation section is reduced and the inner wall of the deformation section abuts or is pressed against the line. Particularly, no gap remains between the deformation section and the line through which ignition media, such as sparks, hot gases or flames could pass in order to ignite an explosive atmosphere. Potentially remaining gaps are flame-proof gaps according to the relevant standard, particularly DIN EN 60071-1 (according to IEC 60079-1).

Prior to or after plastic deformation of the deformation section and the creation of the connection between the connection body and the line, the connection body, by means of its connection section, is arranged in flame-proof manner in the feed-through opening of the outer part or in the wall opening.

### BRIEF DESCRIPTION OF THE DRAWINGS

Advantageous embodiments of the present disclosure are derived from the dependent claims, the description and the drawing. In the following, preferred embodiments of the present disclosure are explained in detail based on the attached drawing. The drawing shows:

FIG. 1 is a side view of an embodiment of an explosion-proof line feed-through in a partly cut illustration,

FIG. 2 is a side view of a connection body of the explosion-proof line feed-through according to FIG. 1 in a partly cut illustration,

FIG. 3 is a side view of an embodiment of an explosion-proof line feed-through in a partly cut illustration,

FIG. 4 is a side view of a connection body of the explosion-proof line feed-through of FIG. 3 in a partly cut illustration,

FIG. 5 is a side view of an embodiment of an explosion-proof line feed-through,

FIG. 6 is a side view of a connection body of the explosion-proof line feed-through of FIG. 5 in partly cut illustration,

FIG. 7 is a longitudinal section through an embodiment of a connection body according to the present disclosure being in an initial condition and

FIG. 8 illustrates the connection body of FIG. 7 in a use condition after plastic deformation of a deformation section.

### DETAILED DESCRIPTION

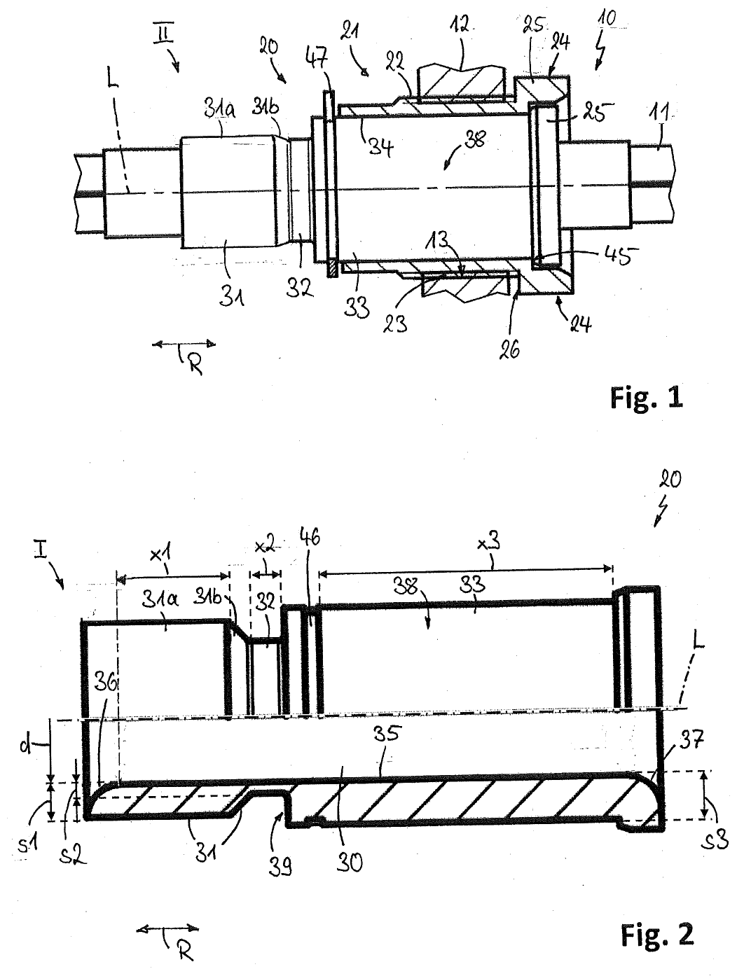

An embodiment of an explosion-proof line feed-through 10 is illustrated in FIGS. 1, 3, and 5 respectively. The explosion-proof line feed-through serves to guide a line 11 through a housing wall 12 in an explosion-proof and according to the example in a flame-proof manner. For this purpose, the explosion-proof line feed-through 10 is arranged in a wall opening 13 of housing wall 12 in an explosion-proof and according to the example in a flame-proof manner. The housing wall 12 can be part of an explosion-proof housing that can be configured, for example, in the explosion-protection type “flame-proof enclosure (Ex-d)” according to DIN EN 60071-1 (corresponding to IEC 60079-1). The explosion-proof line feed-through 10 is configured so that it complies with the requirements to the explosion protection type of the housing.

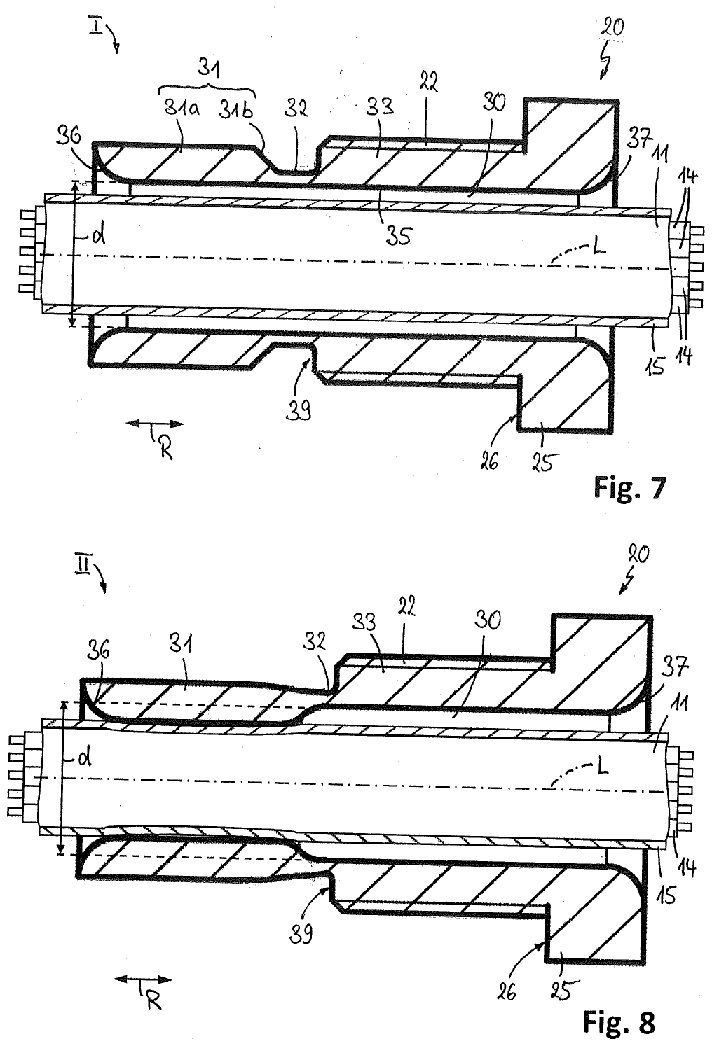

For example, line 11 can comprise at least one conductor, for example at least one electrical conductor 14 and/or at least one optical conductor. As exemplarily illustrated in FIGS. 7 and 8, line 11 can have multiple cores. The number of the electrical conductors 14 and/or the optical conductors is arbitrary and may vary.

Optionally, line 11 can have a sheath 15 that encloses the at least one electrical conductor 14 and/or optical conductor.

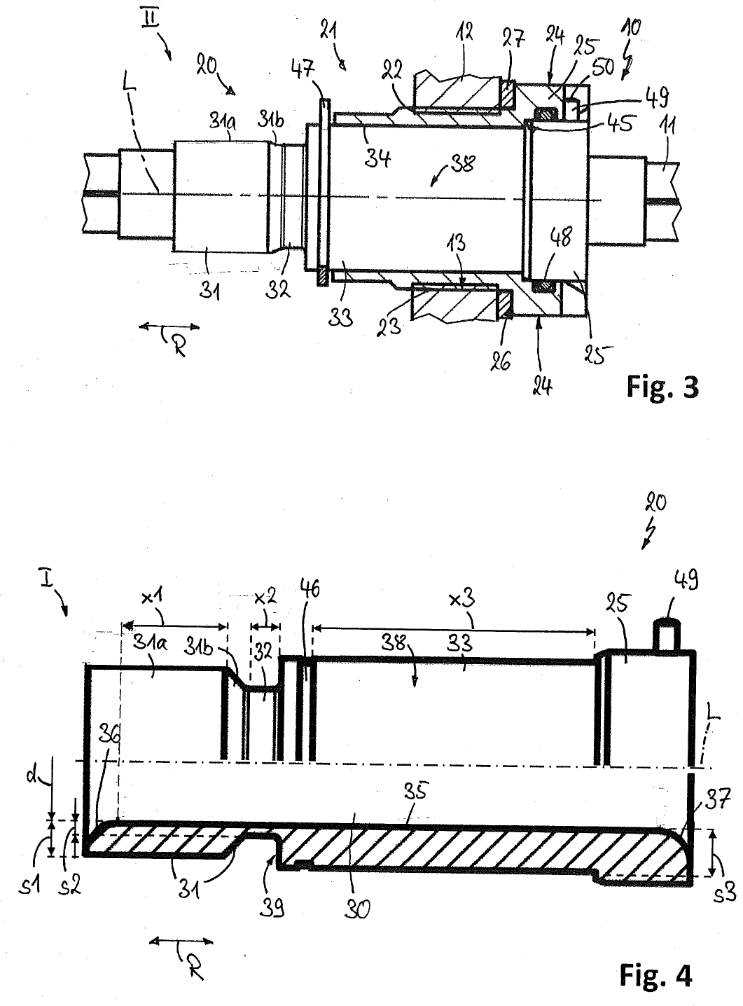

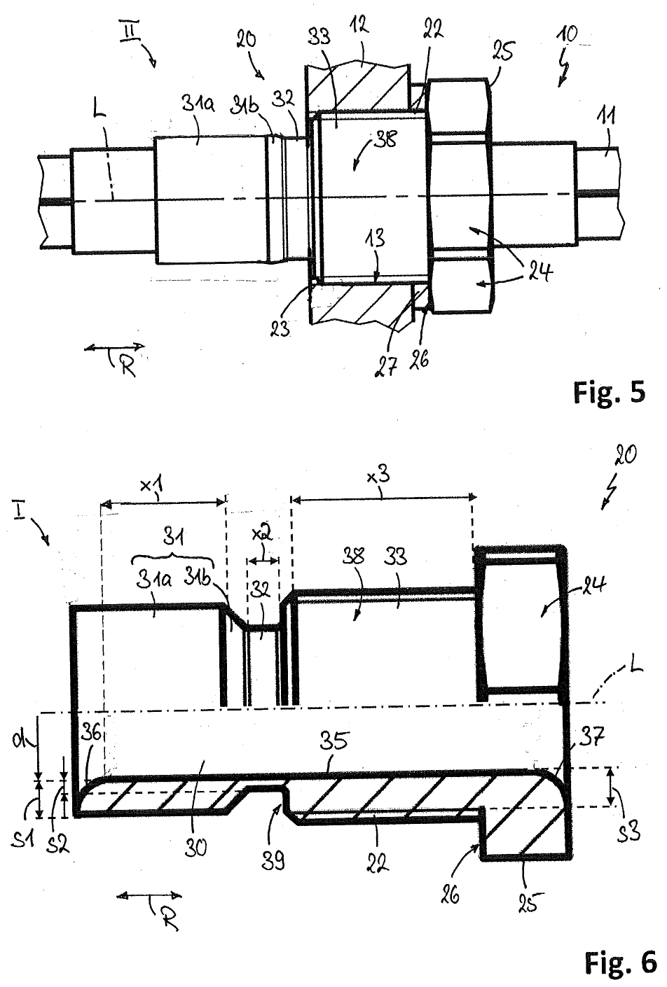

The explosion-proof line feed-through 10 comprises a connection body 20 and optionally an outer part 21. The connection body 20 or optionally outer part 21 is configured to be arranged in a wall opening 13 in flame-proof manner, for example by means of an external thread 22 on the connection body 20 or on the outer part 21 that can be screwed into an internal thread 23 of wall opening 13 for forming a flame-proof threaded gap. In the embodiments according to FIGS. 1 and 3, an outer part 21 having an external thread 22 is provided. In the explosion-proof line feed-through 10 according to FIG. 5, the external thread is provided on connection body 20 which is directly screwed into the internal thread 23 of wall opening 13. An outer part 21 is not present in this embodiment.

Preferably, the body or component of the explosion-proof line feed-through 10 having the external thread 22 comprises tool engagement surfaces 24, so that the connection body 20 or alternatively the outer part 21 can be screwed into the internal thread 23 of wall opening 13. In the embodiment the tool engagement surfaces 24 are configured similar to a nut and form an external hexagon. In modification to this, the tool engagement surfaces 24 could also form an internal hexagon or any other suitable arrangement. The tool engagement surfaces 24 are arranged on a longitudinal end section according to the example.

As illustrated in FIGS. 1, 3 and 5, tool engagement surfaces 24 are provided on a flange 25 of outer part 21 (FIGS. 1 and 3) or on the connection body 20 (FIGS. 5 and 6), wherein the flange projects radially beyond the directly adjacent part or section of the outer part 21 or connection body 20 and thus forms a contact surface 26 extending in ring-shaped manner around a longitudinal axis L. Optionally, a gasket 27 can be arranged between flange 25 and housing wall 12 (FIGS. 3 and 5). This gasket 27 can be arranged between the contact surface 26 and a surface area of housing wall 12 around the wall opening 13 and can be optionally compressed. By means of gasket 27, in addition to the required explosion protection type, a sealing against ingress of water, dust, etc. can be achieved in order to fulfill a respective IP protection category.

In all embodiments connection body 20 comprises a line channel 30 that extends completely through the connection body 20 along a longitudinal axis L of connection body 20. The direction parallel to the longitudinal axis L of the connection body 20 is denoted as longitudinal direction R. The line channel 30 is configured to guide the line 11 through the connection body 20. In an initial condition I of connection body 20, it is possible to insert the line 11 into the line channel 30 and to guide it through the line channel 30.

The initial condition I is illustrated in FIGS. 2, 4, 6 and 7. FIGS. 1, 3, 5 and 8 show the connection body 20 in a use condition II in which connection body 20 is connected with the line 11 in a force-fit and flame-proof manner.

In all embodiments the connection body 20 comprises a deformation section 31, a transition section 32 and a connection section 33. The transition section 32 is arranged between the deformation section 31 and the connection section 33 and particularly directly adjoins the deformation section 31 and the connection section 33. In the embodiment, deformation section 31 is an axial end section of connection body 20. Analog to this, also the connection section 33 can be an axial end section of connection body 20.

The connection section 33 is configured to be connected in flame-proof manner in a feed-through opening 34 in the outer part 21 (FIGS. 1 and 3) or alternatively to be arranged in flame-proof manner in the wall opening 13 (FIG. 5).

At least the deformation section 31 and the transition section 32 consist of a plastically deformable material that particularly allows cold forming. The deformation section 31 is configured according to the example that a deformation degree with diameter changes of up to 10% or up to 15% or up to 20% or up to 25% are possible.

For example, a metal or a metal alloy, particularly a steel alloy, can be used as plastically deformable material. Preferably the entire connection body 20 is monolithically configured and thus consists of a uniform plastically deformable material.

In the initial condition I line channel 30 has a minimum diameter that is defined by the diameter of a central channel section 35. The central channel section 35 is hollow cylindrical and has a circular cross-section in the initial condition I of connection body 20. It extends between a first channel end 36 at an axial end of deformation section 31 and a second channel end 37 at an axial end of the connection section 33. Along the two channel ends 36, 37 the diameter of the line channel 30 increases. In the embodiments illustrated here, the connection body 20 is provided with a radius on the inner side facing the line channel 30 at the first channel end 36 and the second channel end 37. The radius is minimum 1.4 mm. The radius can correspond to a first wall thickness Si of deformation section 31. The diameter of central channel section 35 is characterized by reference sign d in the initial condition I.

In the initial condition I, deformation section 31 has a hollow cylindrical first longitudinal part 31a having the first wall thickness s1 as well as a second longitudinal part 31b, wherein the wall thickness in the second longitudinal part 31b decreases with view in longitudinal direction R starting and away from first longitudinal part 31a. For reduction of wall thickness, second longitudinal part 31b can be conical. The conical shape of second longitudinal part 31b is realized by means of a conical outer surface according to the example.

The two longitudinal sections 31a, 31b are arranged adjacent to one another in longitudinal direction R and directly adjoin one another according to the example.

A wall thickness of the transition section 32 is denoted as second wall thickness s2 and a wall thickness of connection section 33 is denoted as third wall thickness s3. The wall thickness of connection section 33 can vary. The third wall thickness s3 refers to an axial area of connection section 33 in which the connection section 33 comprises a connection outer surface 38 provided and configured for forming the flame-proof gap together with feed-through opening 34 or wall opening 13. The connection outer surface 38 can correspond to the circumferential surface of a cylinder and can be configured in planar manner in longitudinal direction R or can alternatively comprise the external thread 22.

At least in the initial condition I and preferably also in the use condition II, the second wall thickness s2 is smaller than the first wall thickness s1 and smaller than the third wall thickness s3. Preferably the wall thickness at any position in the connection section 33 is larger than the second wall thickness s2 and optionally also than the first wall thickness s1. At least the third wall thickness s3 is larger than the first wall thickness s1 in the embodiment.

In use condition II, the first wall thickness s1 can be smaller than in the initial condition I. In use condition II, the second wall thickness s2 can be smaller than in the initial condition I. The third wall thickness s3 has equal amounts in the initial condition I and use condition II.

The first wall thickness s1 of deformation section 32 in the initial condition I is minimum 3.0 mm. With diameters d of central channel section 35 in the initial condition I of less than 12 mm, first wall thickness s1 is in the initial condition I at least as large as 25% of diameter d of central channel section 35.

In order to allow plastic deformation of deformation section 31, is in the embodiment first wall thickness s1 has a maximum amount in the initial condition I that twice the minimum amount for the first wall thickness s1. For example, the first wall thickness s1 can be maximum 6.0 mm.

In the embodiment transition section 32 is hollow cylindrical. In the initial condition I the inner diameter of transition section 32 corresponds to the diameter d of central channel section 35. The wall thickness of transition section 32 (second wall thickness s2) is smaller than 2.0 mm, preferably smaller than 1.5 mm and is 1.0 mm in the embodiment.

The first longitudinal part 31a of deformation section 31 has a length in longitudinal direction R in the initial condition I that is denoted as first length x1. The transition section 32 has a length in longitudinal direction R in the initial condition I that is denoted as second length x2. The connection outer surface 38 has in the initial condition I and in the use condition II a length in longitudinal direction R that is denoted as third length x3. The second length x2 is minimum 2.4 mm. In the embodiment different minimum lengths for the second length x2 are defined depending on the outer diameter of first longitudinal part 31a of deformation section 31 in the initial condition I. If this outer diameter is at most 10 mm, the minimum value for the second length x2 is 2.8 mm. With larger outer diameters, the second length is calculated as follows:

$$x 2 = 0.13 \cdot ( d + 2 \cdot s 1 ) + 1.12 .$$

The first length x1 is the length of the first longitudinal part 31a in longitudinal direction R between the first channel end 36 and the second longitudinal part 31b. The first length x1 is preferably 8.0 mm up to 10 mm. The total length of first longitudinal part 31a and second longitudinal part 31b is preferably minimum 10 mm.

The third length x3 (length of connection outer surface 38) on the connection section 33 is preferably minimum 12.5 mm or minimum 25 mm if the connection outer surface 38 is configured without thread. In the embodiments in which the connection outer surface 38 comprises the external thread 22, the third length x3 can be minimum 8.0 mm or minimum 11 mm.

The connection section 33 has a ring surface 39 directly adjoining the hollow cylindrical transition section 32. According to the example, ring surface 39 is orientated parallel to a plane that in turn is orientated orthogonal to the longitudinal direction R. Relative to this plane, the ring surface 39 could also be inclined in an acute angle, wherein the amount of this acute angle is less than the amount of an angle under which the conical outer surface of the second longitudinal part 31b is inclined relative to this plane.

For producing the explosion-proof line feed-through 10, it is proceeded as follows:

The connection body 20 is provided in the initial condition I. The line 11 is guided through line channel 30 (FIG. 7). The maximum diameter of line 11 corresponds, therefore, to diameter d of line channel 30 in the initial condition I, according to the example to the diameter d of central channel section 35.

Subsequently, deformation section 31 is plastically deformed so that the inner diameter thereof decreases and the inner wall of deformation section 31 adjoining line channel 30 abuts against line 11 and is pressed against line 11. The connection body 20 is then in use condition II (FIG. 8). It is apparent that the outer diameter as well as the inner diameter of deformation section 31 in use condition II is smaller than in the initial condition I. In use condition II, line 11 is clamped or connected in force-fit manner inside deformation section 31 with connection body 20. The connection is flame-proof and does not contain gaps through which ignition media could pass without being extinguished or sufficiently cooled. Remaining gaps have to be flame-proof and have to comprise a sufficient length in longitudinal direction R and a sufficient small cross-section as defined in the standard, particularly DIN EN 60071-1 (according to IEC 60079-1).

The plastic deformation can be carried out by squeezing or compressing first longitudinal part 31a with a tool.

Due to the thin-walled transition section 32, a decoupling of connection section 33 is achieved during plastic deformation of deformation section 31 from the initial condition I into the use condition II. In doing so, it is guaranteed that a plastic deformation is limited to deformation section 31 and transition section 32 and that the connection section 33, particularly at its outer side, maintains a defined size and geometry, which in turn guarantees a flame-proof connection inside wall opening 13 or feed-through opening 34.

The connection body 20 can be arranged directly in the wall opening 13 in flame-proof manner, for example can be screwed in (FIG. 5). Alternatively to this, the outer part 21 can be arranged inside wall opening 13 in flame-proof manner (FIGS. 1 and 3), wherein the connection body 20 in this case is arranged in flame-proof manner with its connection section 33 inside feed-through opening 34 of outer part 21. For example, connection section 33 can be screwed with the external thread 22 in an internal thread on the outer part 21 or on wall opening 13.

In the embodiments illustrated in FIGS. 1 and 3, connection body 20 is inserted into feed-through opening 34 in longitudinal direction R and limits with its connection outer surface 38 and the opposed wall surface of the feed-through opening 34 a flame-proof cylinder gap (without thread).

The order of the steps during production of the explosion-proof line feed-through 10 can vary in order to make the establishment of the connection simple and efficient. For example, it can be useful to first arrange the connection body 20 in the wall opening 13 or the outer part 21 and to only subsequently establish the force-fit connection with line 11, particularly if the connection between the connection body 20 and the wall opening 13 or the outer part 21 is established by a screw connection using the external thread 22 on connection section 33.

In order to secure connection body 20 in the embodiments according to FIGS. 1 and 3 in longitudinal direction R, a securing arrangement can be provided. For example, contact surface 26 or flange 25 can be used as stop for an assigned stop surface 45 on outer part 21. On the side opposite to flange 25, connection section 33 can have an attachment device 46 for a securing element 47 adjacent to the connection outer surface 38. For example, attachment device 46 can be a groove into which a securing element 47, for example a securing bracket or snap ring, can be arranged. In doing so, connection section 33 can be secured against an undesired movement in longitudinal direction R by means of the securing element 47 on one side and flange 25 on the other side in longitudinal direction R. It is clear that in modification to this, also other securing arrangements could be used in order to secure connection body 20 and particularly connection section 33 against an undesired relative movement at housing wall 12 or outer part 21.

As exemplarily apparent from FIG. 3, also the connection between the connection section 33 and the outer part 21 can be sealed additionally, for example using an O-ring or another sealing element 48. In the embodiment according to FIG. 3, sealing element 48 is arranged in a ring groove of outer part 21 and abuts against flange 25 of connection section 33, if the latter is completely inserted into feed-through opening 34.

As an option, a rotation protection can be provided in order to avoid a relative rotation of connection body 20 around longitudinal axis L relative to the outer part 21. For example, the rotation protection can comprise a securing projection 49 that projects obliquely or orthogonal to the longitudinal direction R from connection section 33 and, for example, from flange 25. The securing projection 49 can engage into a securing recess 50 when the connection with the outer part 21 is established and can be secured inside the securing recess 50 against a rotation movement around the longitudinal axis L.

The present disclosure refers to a connection body 20 for producing an explosion-proof line entry and/or line feed-through 10. The connection body 20 has three sections arranged next to one another in a longitudinal direction R, namely a deformation section 31, a transition section 32 and a connection section 33. The transition section 32 adjoins preferably directly the deformation section 31 and/or connection section 33. The connection body 20 is passed through by a line channel 30 extending in longitudinal direction R, wherein a line 11 can be guided through the line channel 30 in an initial condition I of connection body 20. The deformation section 31 is provided and configured to be plastically deformed so that a flame-proof gap and a force-fit connection is established between the deformation section 31 and the line 11 guided through the line channel 30. The transition section 32 decouples the deformation section 31 from connection section 33 and avoids that the plastic deformation of deformation section 31 also results in an undesired deformation of connection section 33. The connection section 33 is provided and configured to establish a flame-proof connection with a wall opening 13 or a feed-through opening 34 of an outer part 21.

### LIST OF REFERENCE SIGNS

10 explosion-proof line feed-through
11 line
12 housing wall
13 wall opening
14 electrical conductor
15 sheath
20 connection body
21 outer part
22 external thread
23 internal thread of wall opening
24 tool engagement surface
25 flange
26 contact surface
27 gasket
30 line channel
31 deformation section
31a first longitudinal part
31b second longitudinal part
32 transition section
33 connection section
34 feed-through opening
35 central channel section
36 first channel end
37 second channel end
38 connection outer surface
39 ring surface
45 stop surface
46 attachment device
47 securing element
48 sealing element
49 securing projection
50 securing recess
I initial condition
II use condition
D diameter of central channel section
L longitudinal axis
R longitudinal direction
s1 wall thickness of deformation section
s2 wall thickness of transition section
s3 wall thickness of connection section
x1 length of hollow cylindrical part
x2 length of transition section
x3 length of connection outer surface

1. A connection body for producing an explosion-proof line entry and/or line feed-through, comprising:
a line channel extending in a longitudinal direction through the connection body, wherein in an initial condition of connection body the line channel is configured to insert and guide a line therethrough,
a deformation section made of a plastically deformable material configured to be plastically deformed starting from the initial condition of connection body, so that connection body takes a use condition, wherein the deformation section comprises a hollow cylindrical first longitudinal part having a first wall thickness in the initial condition and wherein the deformation section is configured to abut against the line in the use condition and to establish a force-fit and flame-proof connection with the line,
a connection section that is configured to be connected with a feed-through opening of an outer part or with a wall opening in a flame-proof manner, and
a transition section made of a plastically deformable material that connects the connection section with the deformation section, wherein the transition section comprises a second wall thickness that is smaller than the first wall thickness and smaller than a third wall thickness in the connection section in the initial condition of the connection body.

2. The connection body according to claim 1, wherein the line channel is hollow cylindrical and comprises a constant diameter along a central channel section in the initial condition of the connection body, wherein the central channel section extends along the transition section and adjacent to the transition section into the deformation section and the connection section.

3. The connection body according to claim 2, wherein a diameter of the line channel increases at its two opposite channel ends.

4. The connection body according to claim 3, wherein the two opposite channel ends directly adjoin the central channel section.

5. The connection body according to claim 2, wherein in the initial condition of the connection body, the first wall thickness of the deformation section is minimum 25% of a minimum diameter of the line channel.

6. The connection body according to claim 1, wherein the second wall thickness of the transition section in the initial condition of the connection body is smaller than 2.0 mm or smaller than 1.5 mm.

7. The connection body according to claim 1, wherein the first wall thickness of the deformation section in the initial condition of the connection body is minimum 1.35 mm.

8. The connection body according to claim 1, wherein in the initial condition of the connection body, a length of the transition section in longitudinal direction is a minimum of 2.4 mm up to a minimum of 2.8 mm.

9. The connection body according to claim 1, wherein the transition section is hollow cylindrical in the initial condition of the connection body.

10. The connection body according to claim 1, wherein in the initial condition, the deformation section comprises a second longitudinal part in which a wall thickness decreases away from the first longitudinal part in longitudinal direction.

11. The connection body according to claim 1, wherein in the initial condition of connection body, a length of the transition section in longitudinal direction is minimum 10% to 13% of the outer diameter of the deformation section.

12. The connection body according to claim 1, wherein the transition section is limited by a ring surface of the connection section orientated orthogonal to the longitudinal direction.

13. An explosion-proof line entry and/or line feed-through comprising a connection body and a line that extends through a line channel, wherein the connection body comprises a line channel extending in a longitudinal direction through the connection body, wherein the connection body comprises a deformation section and a transition section made of a plastically deformable material as well as a connection section, wherein the transition section connects the connection section with the deformation section, wherein the deformation section of the connection body is plastically deformed in a use condition of the connection body and abuts against the line and thereby is connected to the line in a force-fit and flame-proof manner, and wherein in the use condition a diameter of the line channel along the transition section increases starting from the deformation section toward the connection section.

14. The explosion-proof line entry and/or line feed-through according to claim 13, wherein the connection section is moved in longitudinal direction into or screwed into a feed-through opening of an outer part in a flame-proof manner or wherein the connection section is moved in longitudinal direction into or screwed into a wall opening in a flame-proof manner.

15. A method for producing an explosion-proof line entry and/or line feed-through comprising:
providing a connection body according to claim 1 in the initial condition,
guiding a line through the line channel while the connection body is in the initial condition,
plastically deforming the deformation section inwardly toward the line so that the deformation section abuts against the line and is thereby connected to the line in a force-fit and flame-proof manner,
arranging the connection section of the connection body in a feed-through opening of an outer part or in a wall opening in flame-proof manner.

16. The connection body according to claim 6, wherein the second wall thickness of the transition section in the initial condition of the connection body is 1.0 mm.

17. The connection body according to claim 4, wherein the transition section is hollow cylindrical in the initial condition of the connection body.

18. The connection body according to claim 17, wherein in the initial condition, the deformation section comprises a second longitudinal part in which a wall thickness decreases away from the first longitudinal part in longitudinal direction.

19. The connection body according to claim 18, wherein in the initial condition of connection body, a length of the transition section in longitudinal direction is minimum 10% to 13% of an outer diameter of the deformation section.

20. The connection body according to claim 19, wherein the transition section is limited by a ring surface of the connection section orientated orthogonal to the longitudinal direction.
